(19) United States
(12) Patent Application Publication
(10) Pub. No.: US 2009/0281832 A1
(43) Pub. Date: Nov. 12, 2009

(54) HOSTED INFUSIONAL THERAPEUTICS MANAGEMENT SYSTEMS, METHODS AND COMPUTER PROGRAM PRODUCT

(76) Inventor: Bruce A. Feinberg, Atlanta, GA (US)

Correspondence Address: Ballard Spahr LLP, SUITE 1000, 999 PEACHTREE STREET, ATLANTA, GA, 30309-3915, US

(21) Appl. No.: 12/108,171

(22) Filed: Apr. 23, 2008

Related U.S. Application Data
(60) Provisional application No. 60/913,408, filed on Apr. 23, 2007.

(51) Int. Cl. G06Q 50/00

(52) U.S. Cl. 705/3; 705/2

(57) ABSTRACT

Embodiments according to the present invention provide an online disease management system, method and computer program product that calculates and processes infusional therapy protocols.

### CROSS-REFERENCE TO RELATED APPLICATION

This application claims benefit of and priority to of U.S. Provisional Patent Application Ser. No. 60/913,408, filed Apr. 23, 2007, entitled “Hosted Infusional Therapeutics Management Systems, Methods and Computer Program Product,” which is incorporated herein in its entirety by this reference.

### BACKGROUND

1. Field of the Invention

Embodiments described herein generally relate to medical software systems and methods, more specifically to software utilizing hosted enterprise technology to conduct multilateral transactions between physician provider, pharmaceutical manufacturer and government and private payers that optimizes management of infusional therapeutics for the treatment of chronic and life threatening diseases, and even more specifically to an online chemotherapy management system.

2. Background

Despite published guidelines, numerous on-line information resources, and electronic medical record (EMR) products, the majority of oncologists continue to practice as they have for 20 years: trusting their memory and nurses' support to prescribe and manage cancer treatment. This could be attributable to the complexity and inflexibility of current systems as well as the time required to implement and learn a new system. Further complicating the issue is the use of locally installed systems that can require complicated installation and customization steps, as well as maintenance updates. The ever-growing complexity of cancer management makes this approach increasingly risky for both patient and provider.

Therefore, embodiments according to this invention provide a way to overcome challenges found in the art, some of which are described above.

### SUMMARY

Embodiments described herein provide systems, methods and computer program product for providing hosted enterprise technology to conduct multilateral transactions between physician provider, pharmaceutical manufacturer and government and private payers that facilitates management of infusional therapeutics for the treatment of chronic and life threatening diseases.

Described herein are embodiments of an online disease management system, method and computer program product that calculates and processes infusional therapy protocols.

Embodiments according to the present invention enhance patient care. In one aspect patient care is enhanced by providing oncology professionals the latest treatment protocols, with strict adherence to the published dose, schedule, and administration guidelines.

In another aspect, patient care is enhanced by increasing the efficiency with which infusional treatment orders (e.g., (chemotherapy orders) and related documents are generated.

In another aspect, patient care is enhanced by reducing prescribing mistakes, administration errors, patient risk, and physician liability.

Additional advantages of the invention will be set forth in part in the description which follows, and in part will be obvious from the description, or may be learned by practice of the invention. The advantages of the invention will be realized and attained by means of the elements and combinations particularly pointed out in the appended claims. It is to be understood that both the foregoing general description and the following detailed description are exemplary and explanatory only and are not restrictive of the invention, as claimed.

### BRIEF DESCRIPTION OF THE DRAWINGS

The accompanying drawings, which are incorporated in and constitute a part of this specification, illustrate embodiment(s) of the invention and together with the description, serve to explain the principles of the invention:

FIG. 1A is an exemplary computing device that can be used to practice aspects of the preferred embodiment;

FIG. 1B is an alternative embodiment of a processing system of that shown in FIG. 1A that may be used in embodiments according to the present invention;

FIG. 2 is an exemplary flow chart for a process of online management of infusional therapy according to an embodiment of the present invention;

FIG. 3 is an illustration of an exemplary introductory screen that can be displayed, which allows various options to be selectively chosen by a user according to an embodiment of the present invention;

FIG. 4 is an illustration of an exemplary registration/login screen that can be displayed and can receive input login/registration information according to an embodiment of the present invention;

FIG. 5 is an illustration of an exemplary patient information entry screen that can be displayed and can receive input patient information according to an embodiment of the present invention;

FIGS. 6A-6E are illustrations of exemplary protocol selection screens that can be displayed and can display various disease and treatment indications and appropriate treatment protocols based on input patient information and selections made by a user according to the logic of an embodiment of the present invention;

FIG. 7 is an illustration of an exemplary protocol summary screen that can be displayed and that can display a protocol summary determined by the inputs received or selections made in one or more of FIGS. 5-6E according to an embodiment of the present invention; and

FIGS. 8A-8D illustrate various summaries, educational materials, informed consents, orders, and reports that can be created and printed according to an embodiment of the present invention.

### DETAILED DESCRIPTION

The present invention may be understood more readily by reference to the following detailed description of embodiments of the invention and the Examples included therein and to the figures and their previous and following description.

As used in the specification and the appended claims, the singular forms “a,” “an” and “the” include plural referents unless the context clearly dictates otherwise. Thus, for example, reference to “a” or “an” endpoint device may include two or more endpoint devices.

Ranges may be expressed herein as from “about” one particular value, and/or to “about” another particular value. When such a range is expressed, another embodiment includes from the one particular value and/or to the other particular value. Similarly, when values are expressed as approximations, by use of the antecedent “about,” it will be understood that the particular value forms another embodiment. It will be further understood that the endpoints of each of the ranges are significant both in relation to the other endpoint, and independently of the other endpoint.

In this specification and in the claims which follow, reference will be made to a number of terms which shall be defined to have the following meanings: “Optional” or “optionally” means that the subsequently described event or circumstance may or may not occur, and that the description includes instances where said event or circumstance occurs and instances where it does not. “Exemplary,” as used herein, means “an example of” and is not intended to convey an ideal or preferred embodiment.

Reference will now be made in detail to the present embodiments according to the invention, examples of which are illustrated in the accompanying drawings. Wherever possible, the same reference numbers are used throughout the drawings to refer to the same or like parts.

As will be appreciated by one skilled in the art, the embodiments or aspects of embodiments may be implemented as a method, a data processing system, or a computer program product. Accordingly, the embodiments may take the form of an entirely hardware embodiment, an entirely software embodiment, or an embodiment combining software and hardware aspects. Furthermore, implementations of the embodiments or aspects of the embodiments may take the form of a computer program product on a computer-readable storage medium having computer-readable program instructions (e.g., computer software) embodied in the storage medium. More particularly, implementations of the embodiments may take the form of web-implemented computer software. Any suitable computer-readable storage medium may be utilized including hard disks, CD-ROMs, optical storage devices, magnetic storage devices, etc.

The embodiments according to the present invention are described below with reference to block diagrams and flowchart illustrations of methods, apparatuses (i.e., systems) and computer program products according to embodiments of the invention. It will be understood that each block of the block diagrams and flowchart illustrations, and combinations of blocks in the block diagrams and flowchart illustrations, respectively, can be implemented by computer program instructions. These computer program instructions may be loaded onto a general purpose computer, special purpose computer, or other programmable data processing apparatus, such as the ones described below, to produce a machine, such that the instructions which execute on the computer or other programmable data processing apparatus create a means for implementing the functions specified in the flowchart block or blocks.

These computer program instructions may also be stored in a computer-readable memory that can direct a computer or other programmable data processing apparatus to function in a particular manner, such that the instructions stored in the computer-readable memory produce an article of manufacture including computer-readable instructions for implementing the function specified in the flowchart block or blocks. The computer program instructions may also be loaded onto a computer or other programmable data processing apparatus to cause a series of operational steps to be performed on the computer or other programmable apparatus to produce a computer-implemented process such that the instructions that execute on the computer or other programmable apparatus provide steps for implementing the functions specified in the flowchart block or blocks.

Accordingly, blocks of the block diagrams and flowchart illustrations support combinations of means for performing the specified functions, combinations of steps for performing the specified functions and program instruction means for performing the specified functions. It will also be understood that each block of the block diagrams and flowchart illustrations, and combinations of blocks in the block diagrams and flowchart illustrations, can be implemented by special purpose hardware-based computer systems that perform the specified functions or steps, or combinations of special purpose hardware and computer instructions.

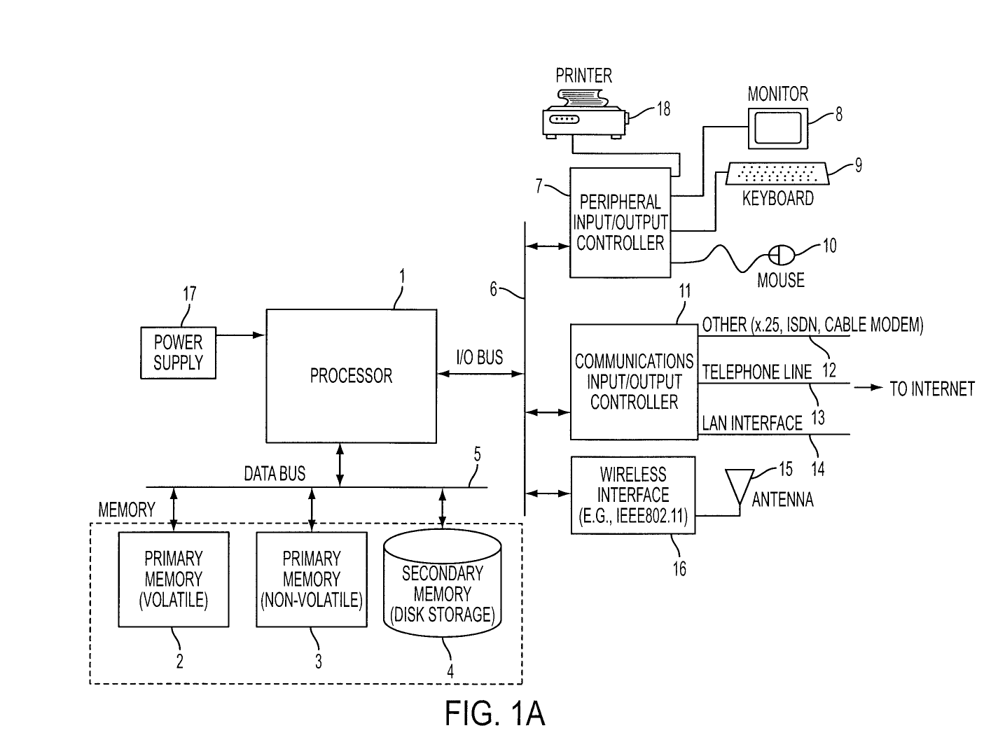

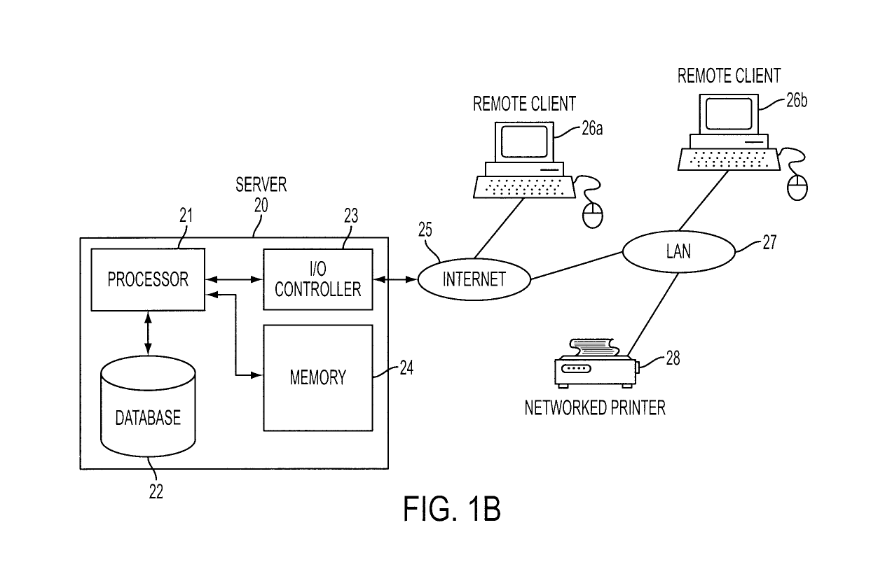

In the embodiments referenced herein, a “computer,” “computing device,” “controller,” or “server” may be referenced for carrying out steps according top the invention. Such computer may be, for example, a mainframe, desktop, notebook or laptop, a hand held device such as a data acquisition and storage device, or it may be a processing device embodied within another apparatus such as, for example, a processor incorporated into another device or system or network devices having processors. In some instances the computer may be a “dumb” terminal used to access data or processors over a network such as the Internet. Turning to FIG. 1A, one embodiment of a computing device is illustrated that can be used to practice aspects of the preferred embodiment. In FIG. 1A, a processor 1, such as a microprocessor, is used to execute software instructions for carrying out the defined steps. The processor receives power from a power supply 17 that also provides power to the other components as necessary. The processor 1 communicates using a data bus 5 that is typically 16 or 32 bits wide (e.g., in parallel). The data bus 5 is used to convey data and program instructions, typically, between the processor and memory. In the present embodiment, memory can be considered primary memory 2 that is RAM or other forms which retain the contents only during operation, or it may be non-volatile 3, such as ROM, EPROM, EEPROM, FLASH, or other types of memory that retain the memory contents at all times. The memory could also be secondary memory 4, such as disk storage, that stores large amount of data. In some embodiments, the disk storage may communicate with the processor using an I/O bus 6 instead or a dedicated bus (not shown). The secondary memory may be a floppy disk, hard disk, compact disk, DVD, or any other type of mass storage type known to those skilled in the computer arts.

The processor 1 also communicates with various peripherals or external devices using an I/O bus 6. In the present embodiment, a peripheral I/O controller 7 is used to provide standard interfaces, such as RS-232, RS422, DIN, USB, or other interfaces as appropriate to interface various input/output devices. Typical input/output devices include local printers 18, a monitor 8, a keyboard 9, and a mouse 10 or other typical pointing devices (e.g., rollerball, trackpad, joystick, etc.).

The processor 1 typically also communicates using a communications I/O controller 11 with external communication networks, and may use a variety of interfaces such as data communication oriented protocols 12 such as X.25, ISDN, DSL, cable modems, etc. The communications controller 11 may also incorporate a modem (not shown) for interfacing and communicating with a standard telephone line 13. Finally, the communications I/O controller may incorporate an Ethernet interface 14 for communicating over a LAN. Any of these interfaces may be used to access a wide area network such as the Internet, intranets, LANs, or other data communication facilities.

Finally, the processor 1 may communicate with a wireless interface 16 that is operatively connected to an antenna 15 for communicating wirelessly with another device, using for example, one of the IEEE 802.11 protocols, 802.15.4 protocol, or a standard 3G wireless telecommunications protocols, such as CDMA2000 1x EV-DO, GPRS, W-CDMA, or other protocol.

An alternative embodiment of a processing system that may be used is shown in FIG. 1B. In this embodiment, a distributed communication and processing architecture is shown involving a server 20 communicating with remote client computers 26a, 26b. The server 20 typically comprises a processor 21 that communicates with a database 22, which can be viewed as a form of secondary memory, as well as primary memory 24. The processor also communicates with external devices using an I/O controller 23 that typically interfaces with a wide-area network such as the Internet 25. Communication with remote devices typically is accomplished by routing data from the network 25 over a communications facility to a local area network (LAN) 27. The LAN 27 may provide local connectivity to a networked printer 28 and remote client computers 26a, 26b. These may be located in the same facility as the server, though not necessarily in the same room. Remote client computers 26a, 26b may execute a web browser, so that the remote client 26a, 26b may interact with the server as required by transmitted data through the wide area network 25, over the LAN 27, and to the server 20.

Those skilled in the art of data networking will realize that many other alternatives and architectures are possible and can be used to practice the preferred embodiments. The embodiments illustrated in FIGS. 1A and 1B can be modified in different ways and be within the scope of the present invention as claimed.

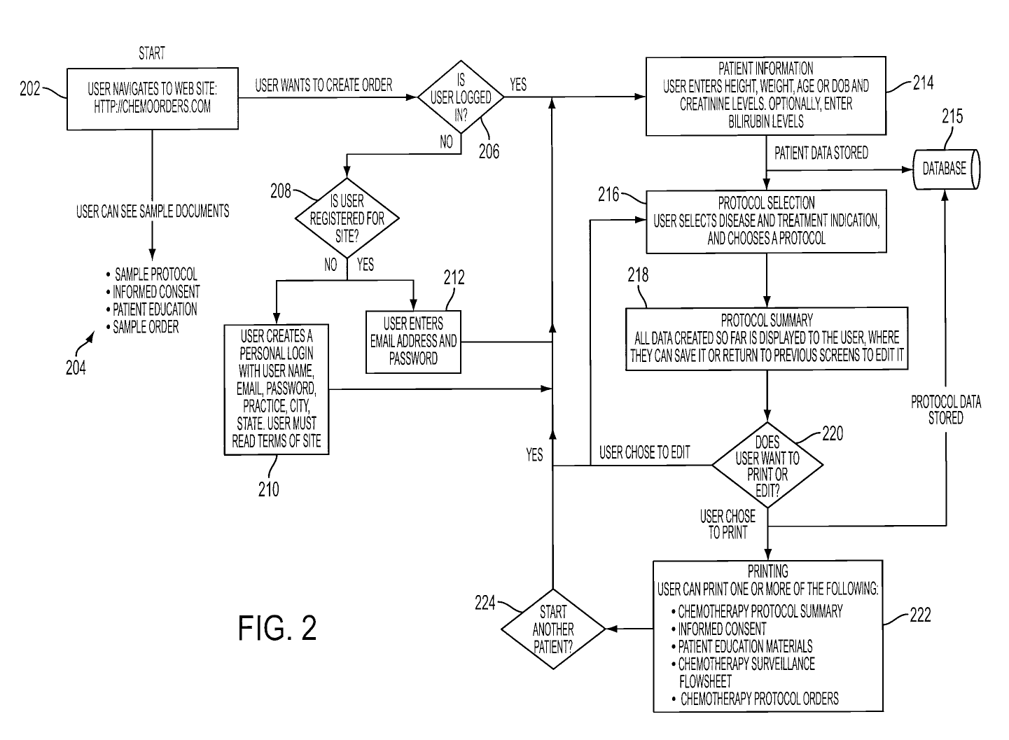

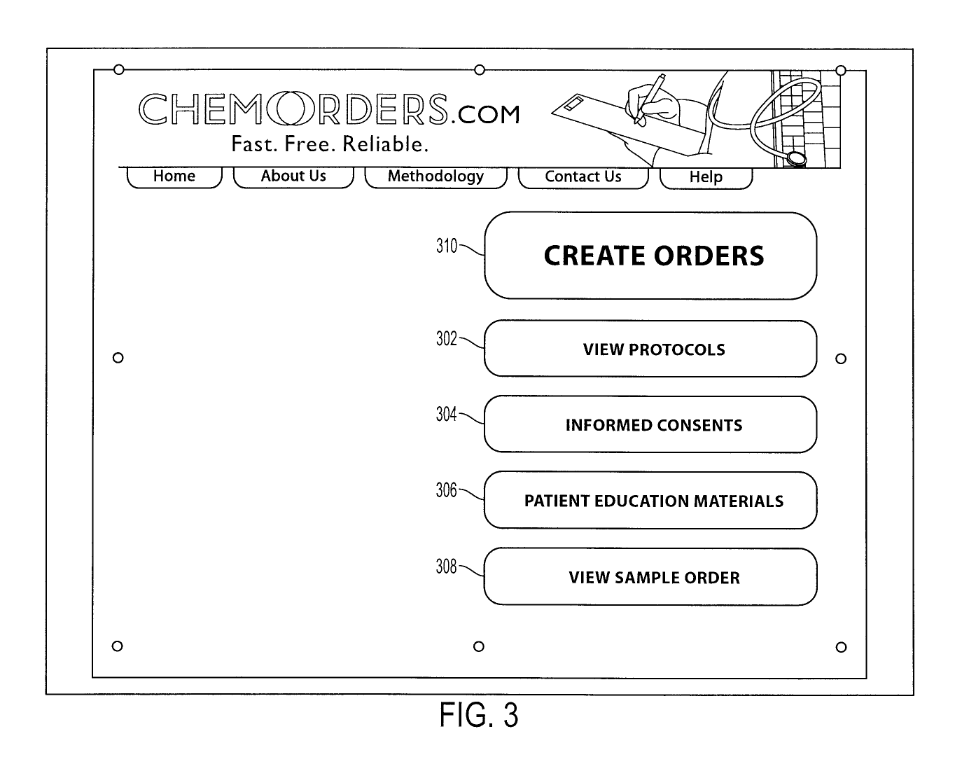

Aspects according to the present invention provide systems, methods and computer program product for providing hosted enterprise technology to conduct multilateral transactions between physician provider, pharmaceutical manufacturer and government and private payers that optimizes management of infusional therapeutics for the treatment of chronic and life threatening diseases. In various embodiments, a system, method and computer program product for managing chemotherapy treatment protocols are provided. FIG. 2 is an exemplary flow chart for a process of online management of infusional therapy according to an embodiment of the present invention. The process begins at step 202, where a user utilizes browser software (e.g. Microsoft Internet Explorer, NetScape, Mozilla Firefox, etc.), as are known to one of ordinary skill in the art, operating on a computer such as the computers described in FIGS. 1A and 1B, to navigate to a network location such as, for example, the website http://chemoorders.com, using a network such as the Internet. The website is hosted on one or more servers having associated memories and processors. Once at step 202 the user has navigated to the desired location, a screen is displayed on a display associated with the computer, such as the one shown in FIG. 3.

FIG. 3 is an illustration of an exemplary introductory screen that can be displayed, which allows various options to be selectively chosen by a user according to an embodiment of the present invention. As shown in step 204, in one aspect a user can selectively choose to view sample documents from the exemplary screen of FIG. 3. For instance, the user may use a mouse and a cursor or other input devices to selectively choose to view one or more of a sample protocol 302, an informed consent 304, patient educational materials 306 or a sample order 308. It is to be appreciated that this screen (FIG. 3) can be modified or customized to include more, fewer or different exemplary documents and information. The screen of FIG. 3 also provides a user with the option to selectively choose to create an order 310.

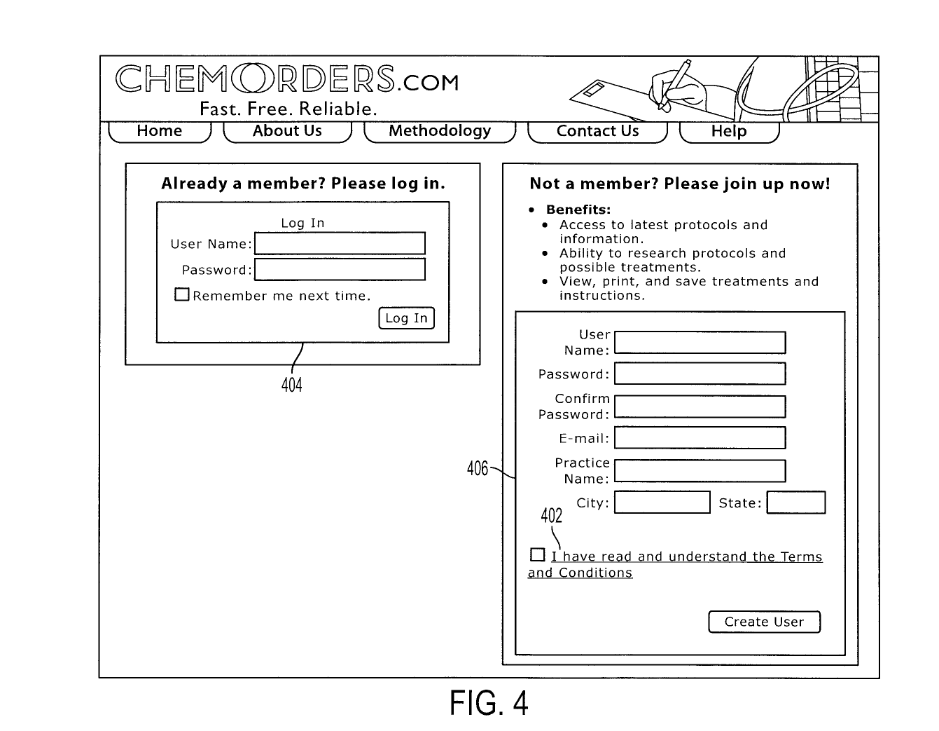

If a user elects to create an order 310, then the process of FIG. 2 goes to step 206. At step 206 it is determined whether the user has logged into the hosted infusional treatment system according to the present invention. If, at step 206, the user has not logged in, then the process goes to step 208 and FIG. 4 is displayed. FIG. 4 is an illustration of an exemplary registration/login screen that can be displayed and can receive input login/registration information according to an embodiment of the present invention. At step 208 it is determined whether the user is registered for the site that hosts the online infusional treatment system. This can be accomplished by means known to one of ordinary skill in the art such as, for example, a “cookie” that is received by the browser and stored in the computer's memory, or it can performed by presenting a user with the option of logging in using a user name and a password 404, as is known in the art, or allowing the user to register 406 by providing information such as a user name, password, practice, city, state, etc. Upon providing registration information, in one aspect the user must agree to the terms and conditions of using the site 402 by “clicking” on a box in the screen. The user may view the terms and conditions, which are customizable according to the application, local and federal laws, etc., by “clicking” on the hyperlink associated with the terms and conditions. Upon providing the registration information and accepting the terms and conditions, the registration information is stored in a database in a memory associated with the one or more servers that host the system. This information may go through a validation process and the user may not be allowed access to the infusional treatment management system until the information is validated. If, at step 208 the user is registered to use the site, then the user can provide their user name and password, which are validated against the user's information in the database, and allowed access to the site if their information is valid.

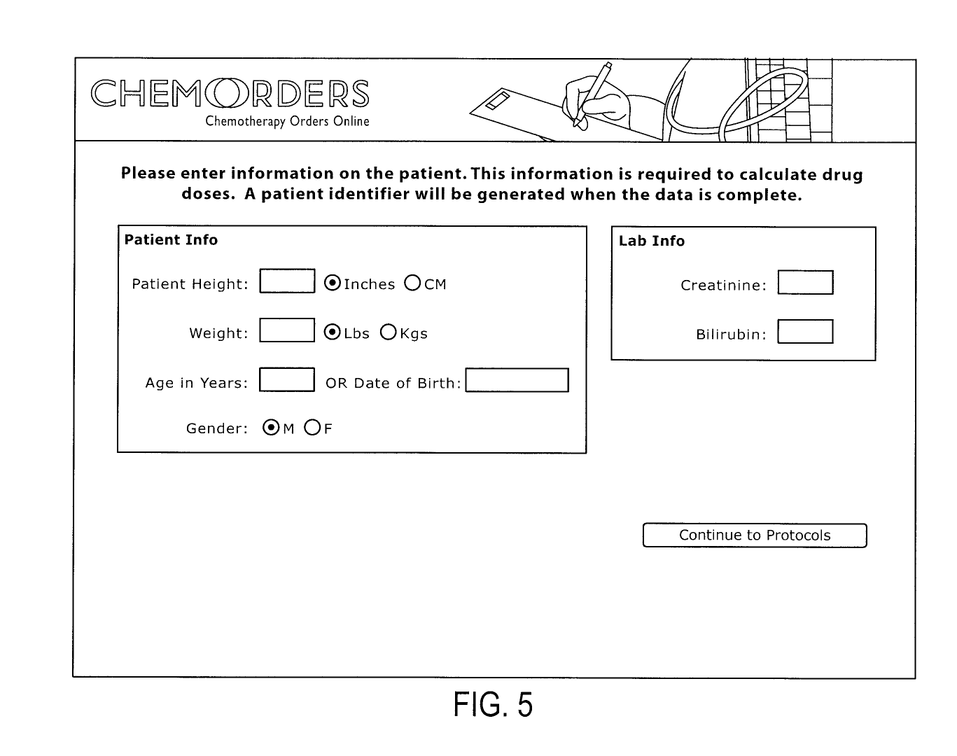

Once, at step 210 a user registers and is provided access, or at step 212 logs into the system, respectively, or, if at step 206 it is determined that the user is already logged into the system, then the process goes to step 214. In one aspect, at step 214, the screen of FIG. 5 is displayed. FIG. 5 is an illustration of an exemplary patient information entry screen that can be displayed and can receive input patient information according to an embodiment of the present invention. At step 214, and through the use of the screen of FIG. 5, information about a patient is entered into the system. This information includes, for example, patient vitals information such as patient height, weight, age, gender, etc. Lab information can also be input, which can include, for example, creatinine level and bilirubin level. Further, in one aspect additional patient history information can be requested and input such as whether the patient has had prior chemotherapy treatment or prior radiation therapy treatment and the performance status of such prior treatment. It is to be appreciated that other patient and lab-specific information can be entered by modifying this screen. Furthermore, it is to be appreciated that this screen and the information entered therein complies with patient privacy laws such as the Health Insurance Portability and Accountability Act (HIPAA) of 1996 as there is no identifier such as a name, social security number, hospital patient number, etc. associated with the information that can be used to discover the identity of the patient. In one aspect, the information is not stored in a database and is only used to calculate drug doses using the computer's random access memory or volatile memory. In another aspect, the patient information is stored in a database 215 associated with the infusional therapy system, though not identifiable to a specific patient. This information can later be used to determine the effectiveness of specific infusional protocols based on physical attributes of patients such as their age, weight, gender, etc. In one aspect, a patient identifier is generated when the data is complete, but this identifier is used only to identify the entered information, and does not create a record that associates the information to a specific person, in accordance with privacy laws. Once patient information is entered, the process goes to step 216.

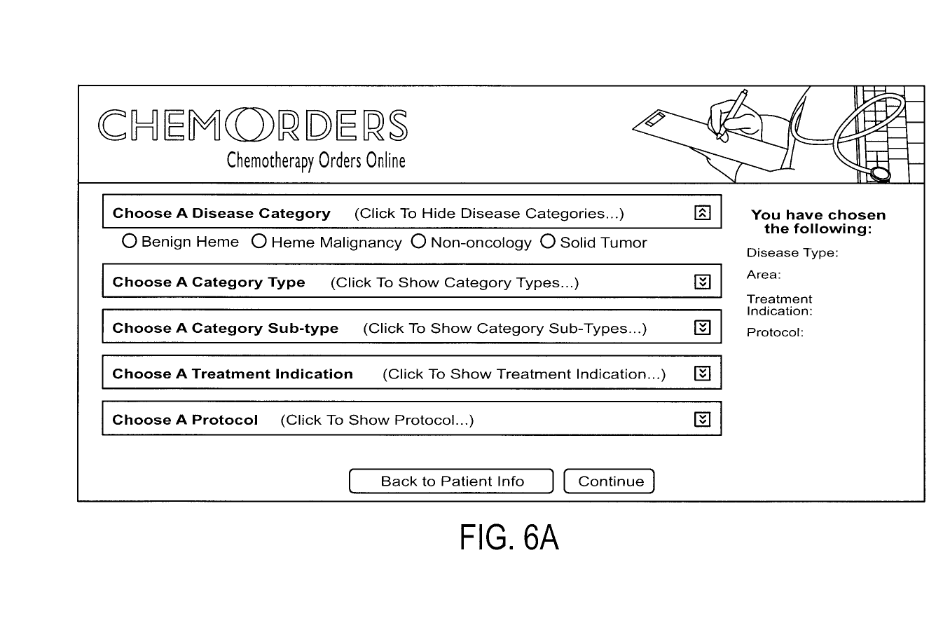

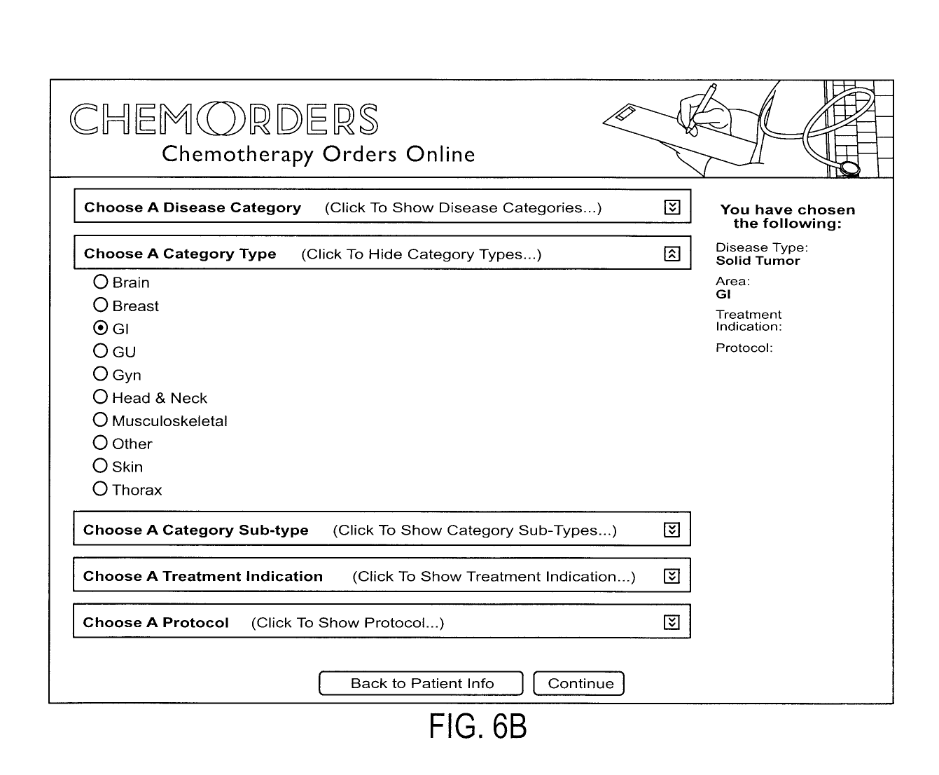

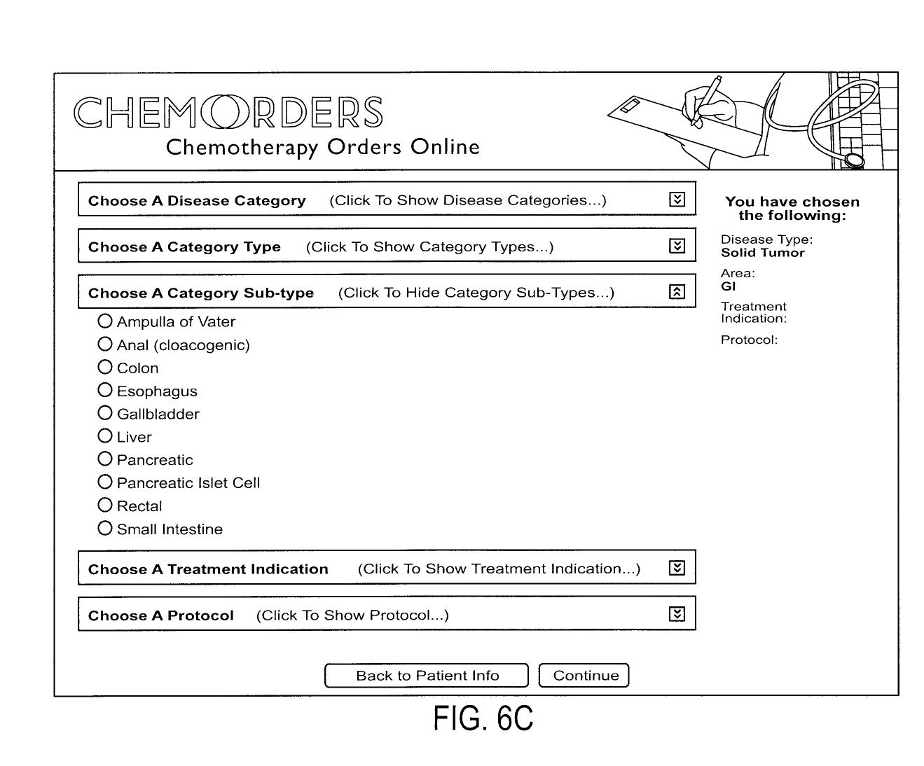

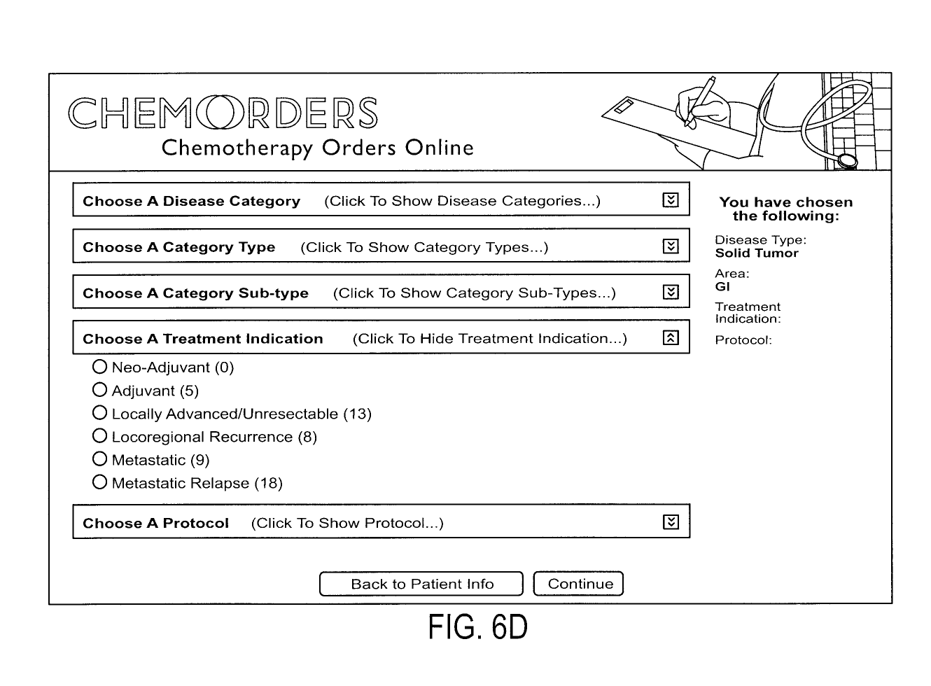

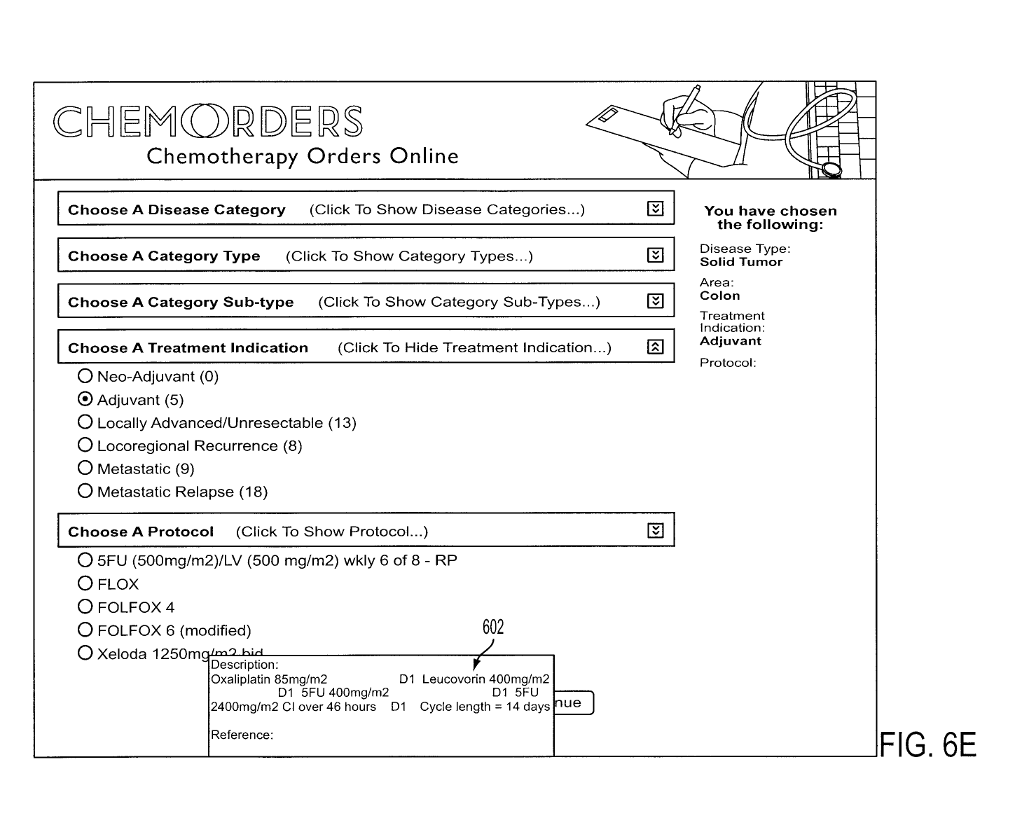

At step 216, a series of screens are provided to the user to allow the user to enter disease and treatment indications. The system then suggests one or more treatment protocols that are determined by the system based on patient information and the disease and treatment indications. In one aspect, the series of screens can be similar to those shown in FIGS. 6A-6E.

FIGS. 6A-6E are illustrations of exemplary protocol selection screens that can be displayed and can display various disease and treatment indications and appropriate treatment protocols based on input patient information and selections made by a user according to the logic of an embodiment of the present invention. Referring to FIG. 6A, a user can selectively choose a disease category such as, for example, “Benign Heme,” “Heme Malignancy,” “Non-oncology,” and a “Solid Tumor.” It is to be appreciated that more, fewer or different disease categories are contemplated under the scope of this invention, depending upon the infusional therapies being managed. In FIG. 6B, a user can selectively choose a category type, which is (logically) dependent upon the disease category chosen in FIG. 6A. For example, if “Solid Tumor” is selectively chosen as the disease category in FIG. 6A, then in FIG. 6B the user is provided the options of selectively choosing the following category types: Brain, Breast, GI, GU, Gyn, Head & Neck, Muscoskeletal, Other, Skin, and Thorax. It is to be appreciated that more, fewer or different category types are contemplated under the scope of this invention, depending upon the infusional therapies being managed and the disease category selectively chosen. In the exemplary screen of FIG. 6B, it can be seen that the category type of “GI” has been selectively chosen by the user

Similarly, FIG. 6C illustrates a screen that allows a user to selectively choose a category sub-type, which is (logically) dependent upon the disease category chosen in FIG. 6A and the category type chosen in FIG. 6B. For example, if “Solid Tumor” is selectively chosen as the disease category in FIG. 6A, and “GI” is chosen as the category type in FIG. 6B, then in FIG. 6C the user is provided the options of selectively choosing the following category sub-types: Ampulla of Vater, Anal (cloacogenic), Colon, Esophagus, Gallbladder, Liver, Pancreatic, Pancreatic Islet Cell, Rectal and Small Intestine. It is to be appreciated that more, fewer or different category sub-types are contemplated under the scope of this invention, depending upon the infusional therapies being managed, the disease category selectively chosen, and the category type selectively chosen.

FIG. 6D illustrates a screen that allows a user to selectively choose a treatment indication, which is (logically) dependent upon the disease category chosen in FIG. 6A, the category type chosen in FIG. 6B, and the category sub-type chosen in FIG. 6C. For example, if “Solid Tumor” is selectively chosen as the disease category in FIG. 6A, and “GI” is chosen as the category type in FIG. 6B, and “Colon” is chosen as the category sub-type in FIG. 6C, then the user is provided the options of selectively choosing the following treatment indications: Neo-Adjuvant (0), Adjuvant (5), Locally Advanced/Unresectable (13), Locoregional Recurrence (8), Metastatic (9), and Metastatic Relapse (18). It is to be appreciated that more, fewer or different treatment indications are contemplated under the scope of this invention, depending upon the infusional therapies being managed, the disease category selectively chosen, the category type selectively chosen, and the category sub-type selectively chosen.

FIG. 6E illustrates a screen that allows a user to selectively choose an infusional protocol, which is (logically) dependent upon the disease category chosen in FIG. 6A, the category type chosen in FIG. 6B, the category sub-type chosen in FIG. 6C, and the treatment indication chosen in FIG. 6D. For example, if “Solid Tumor” is selectively chosen as the disease category in FIG. 6A, and “GI” is chosen as the category type in FIG. 6B, and “Colon” is chosen as the category sub-type in FIG. 6C, and “Adjuvant” is chosen as the treatment indication in FIG. 6D, then the user is provided the options of selectively choosing the following protocols: 5FU (500 mg/m²)LV (500 mg/m²) wkly 6 of 8-RP, FLOX, FOLFOX 4, FOLFOX 6 (modified), and Xeloda 1250 mg/m² bid. It is to be appreciated that more, fewer or different protocols are contemplated under the scope of this invention, depending upon the infusional therapies being managed, the disease category selectively chosen, the category type selectively chosen, the category sub-type selectively chosen, and the treatment indication selectively chosen. In one aspect, the infusional management system can suggest a preferred protocol based on the selections made in FIGS. 6A-6D. In one aspect, the chosen protocol can be displayed in a pop-up box 602 on the screen, which allows the user to confirm the selected/suggested protocol. In one aspect alerts associated with a chosen protocol can be displayed to the user. Further, in one aspect treatment options per disease and/or indication can be qualified by a key such as (F) to denote U.S. Food & Drug Administration (FDA) approval, (C) to denote compendia listing, and (PF) to denote any patient-friendly regiment modifications that have reduced patient treatment cost and/or toxicity. For example, FOLFOX 6 (modified) (F), (C), (PF).

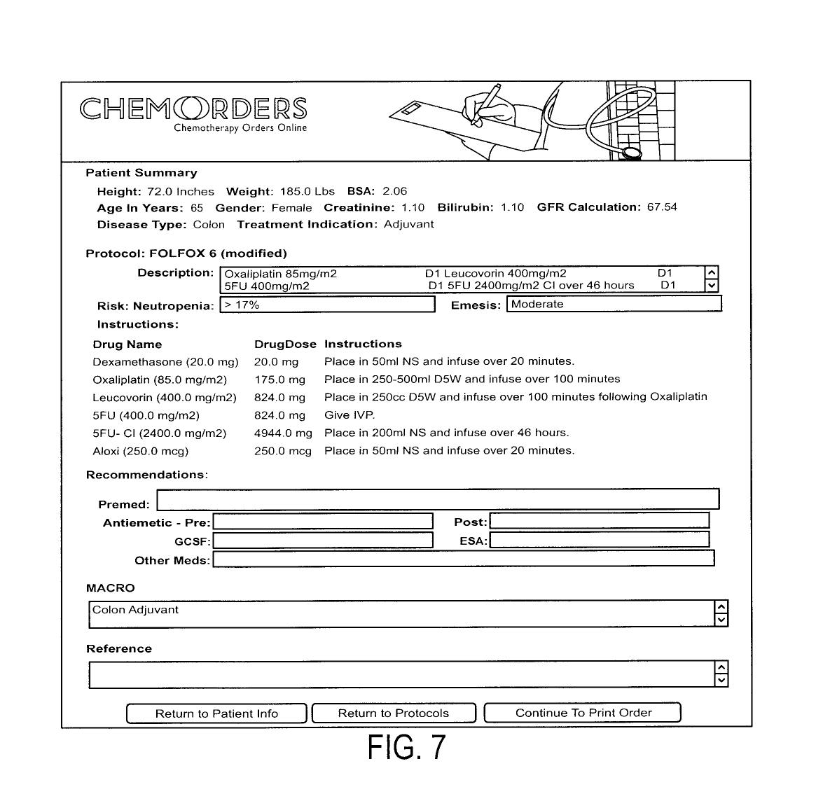

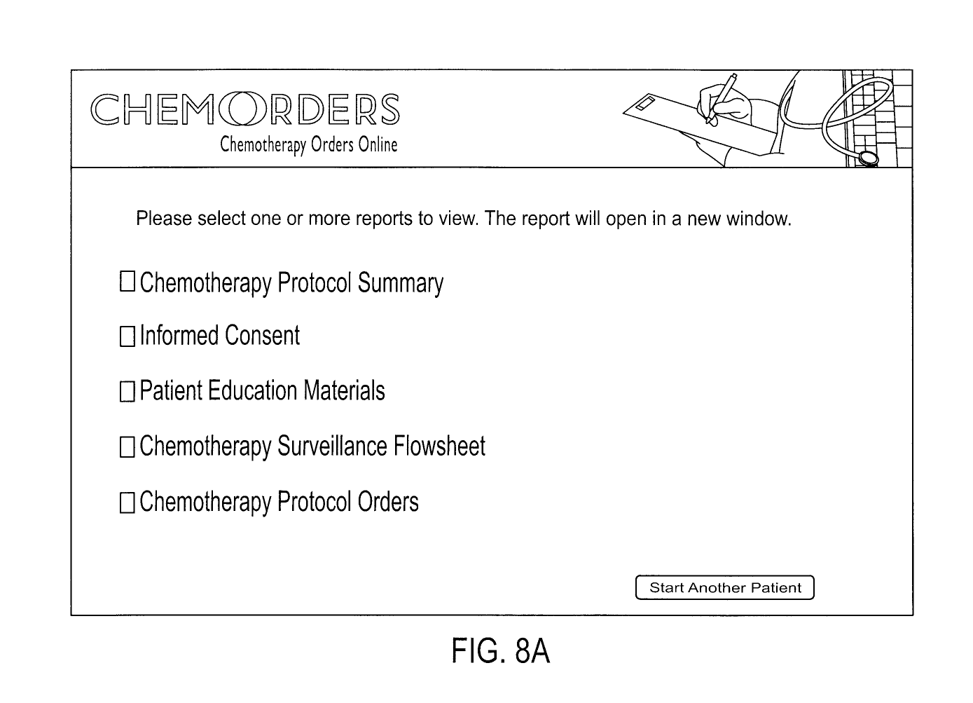

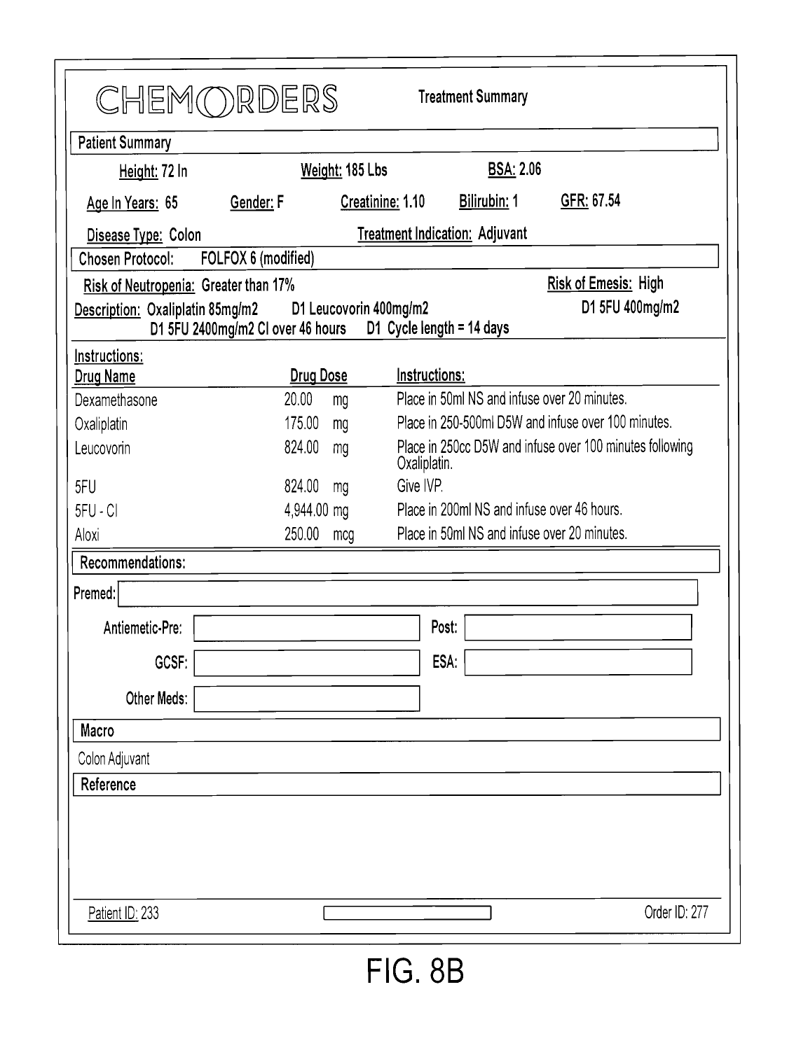

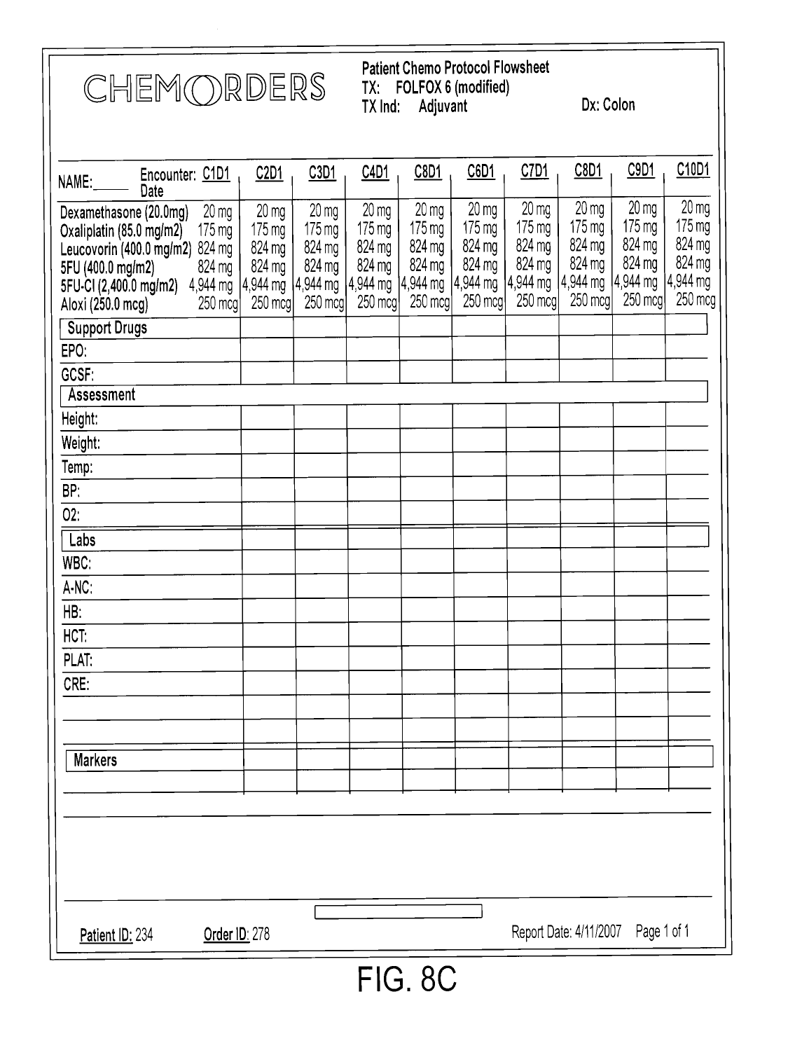

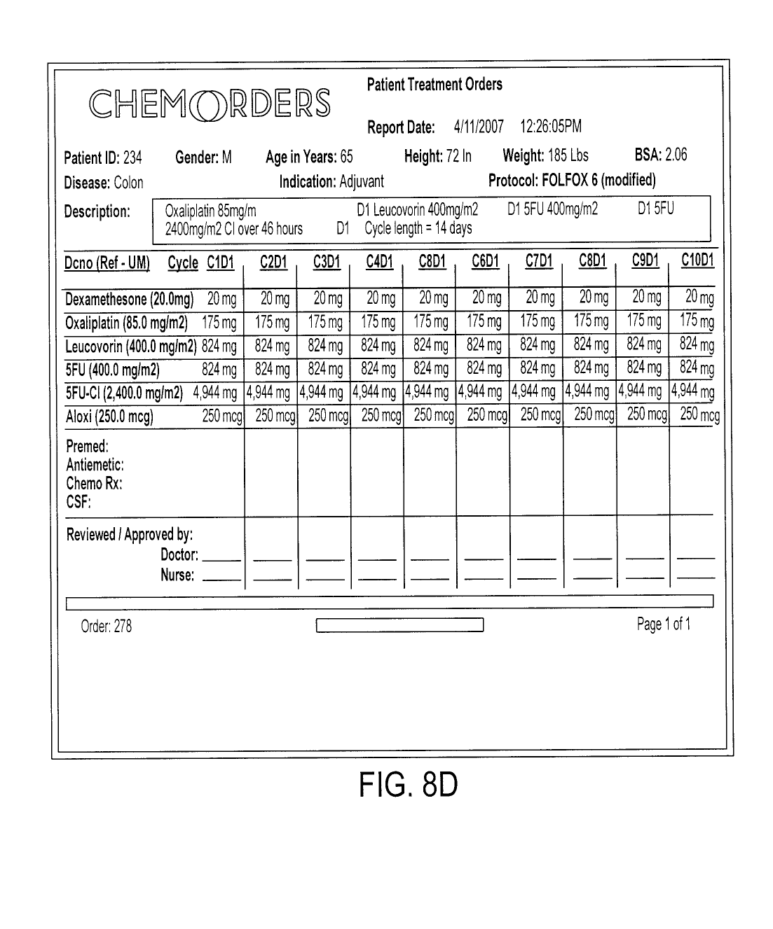

Returning to FIG. 2, once a protocol is selected at step 216, then the process goes to step 218 where a protocol summary is displayed to the user. FIG. 7 is an illustration of an exemplary protocol summary screen that can be displayed and that can display a protocol summary determined by the inputs received or selections made in one or more of FIGS. 5-6E according to an embodiment of the present invention. The user can review the summary and, at step 220, the user can choose to either edit the protocol or to print the summary. If the user chooses to edit the summary, then the user is returned to step 216 in the process. If, at step 220, the user chooses to print the summary, then the process goes to step 222, where the user can print one or more of the following: Protocol Summary (e.g., a Chemotherapy Protocol summary), an Informed Consent, Patient Educational Materials, an Infusional Surveillance Flowsheet (e.g., a Chemotherapy Surveillance Flowsheet), and Infusional Protocol Orders (e.g., Chemotherapy Protocol Orders). FIGS. 8A-8D illustrate various exemplary summaries, educational materials, informed consents, orders, and reports that can be created and printed according to an embodiment of the present invention. In one aspect, an Infusional Protocol Order can be modified by a user.

At step 224, the user is provided the option of determining an infusional therapy protocol for another patient by returning to step 212, otherwise the process ends.

Advantages of the embodiments of the present invention include speed, consistency, ease of use, and flexibility, among others.

### CONCLUSION

The above examples are put forth so as to provide those of ordinary skill in the art with a complete disclosure and description of how the compounds, compositions, articles, devices and/or methods claimed herein are made and evaluated, and are intended to be purely exemplary of the invention and are not intended to limit the scope of what the inventors regard as their invention

Throughout this application, various publications and/or standards may be referenced. The disclosures of these publications in their entireties are hereby incorporated by reference into this application in order to more fully describe the state of the art to which this invention pertains.

It will be apparent to those skilled in the art that various modifications and variations can be made in the present invention without departing from the scope or spirit of the invention. Other embodiments of the invention will be apparent to those skilled in the art from consideration of the specification and practice of the invention disclosed herein. It is intended that the specification and examples be considered as exemplary only.

What is claimed is:

1. A method for providing disease management comprising:
providing a hosted enterprise technology to conduct a plurality of multilateral transactions;
receiving from a user, a plurality of patient information;
receiving from a user, one or more disease and treatment indications;
calculating one or more drug doses for one or more infusional chemotherapy protocols based on the plurality of patient information and the one or more disease and treatment indications; and
providing the one or more infusional chemotherapy protocols to the user.

2. The methods of claim 1, further comprising the user selectively choosing one of the one or more infusional chemotherapy protocols; and generating a protocol order for treatment of the patient based on the selected infusional chemotherapy protocol.

3. The method of claim 2, wherein the user can modify the selected infusional chemotherapy protocol resulting in a modified protocol order for treatment of the patient.

4. The method of claim 1, wherein providing the hosted enterprise technology to conduct the plurality of multilateral transactions comprises a web based internet technology for conducting the plurality of multilateral transactions.

5. The method of claim 1, wherein providing the hosted enterprise technology to conduct multilateral transactions comprises:
transacting with a plurality of physician providers;
transacting with a plurality of pharmaceutical manufacturers;
transacting with a plurality of governmental agencies; and
transacting with a plurality of private entities.

6. The method of claim 1, wherein receiving the plurality of patient information comprises receiving patient information relating to patient vitals and lab information about the patient.

7. The method of claim 6, wherein receiving from a user, one or more disease and treatment indications comprises receiving one or more of a disease category, a disease category type, a disease category sub-type, or a treatment indication.

8. The method of claim 1, wherein providing the one or more infusional chemotherapy protocols to the user comprises:
determining the treatment protocol based on patient information and information from the plurality of multilateral transactions to determine a protocol summary relating to the application of the treatment protocol; and
displaying the protocol summary relating to the application of the treatment protocol.

9. A system for determining therapy protocols comprised of:
an online hosted enterprise system to conduct multilateral transactions;
a user input mechanism operably connected to the online hosted enterprise system;
a display; and
a processor operably connected to the online hosted enterprise system, the user input mechanism and the display, wherein the processor is configured to:
receive a plurality of patient information;
receive one or more disease and treatment indications;
calculate one or more drug doses for one or more infusional chemotherapy protocols based on the plurality of patient information and the one or more disease and treatment indications; and
display the one or more infusional chemotherapy protocols.

10. The system of claim 9, further comprising the processor further configured to receive an indication of a selection of one of the one or more infusional chemotherapy protocols; and generate a protocol order for treatment of the patient based on the selected infusional chemotherapy protocol.

11. The system of claim 10, wherein the processor is further configured to allow a user to modify the selected infusional chemotherapy protocol resulting in a modified protocol order for treatment of the patient.

12. The system of claim 9, wherein the online hosted enterprise system to conduct multilateral transactions comprises a web based internet technology for conducting the plurality of multilateral transactions.

13. The system of claim 12, wherein the online hosted enterprise system to conduct multilateral transactions is configured to host transactions with of physician providers; transactions with of pharmaceutical manufacturers; transactions with governmental agencies; and transactions with private entities.

14. The system of claim 9, wherein the processor configured to receive a plurality of patient information comprises receiving patient information relating to patient vitals and lab information about the patient.

15. The system of claim 9, wherein the processor configured to receive one or more disease and treatment indications comprises receiving one or more of a disease category, a disease category type, a disease category sub-type, or a treatment indication.

16. A computer program product for online disease management comprising computer-executable code sections on a computer-readable medium, said computer-executable code sections comprising:
a first computer-executable code section for receiving a plurality of patient information;
a second computer-executable code section for receiving one or more disease and treatment indications;
a third computer-executable code section for calculating one or more drug doses for one or more infusional chemotherapy protocols based on the plurality of patient information and the one or more disease and treatment indications; and
a fourth computer-executable code section for displaying the one or more infusional chemotherapy protocols.

17. The computer program product of claim 16, further comprising a fifth computer-executable code section that allows a user to selectively choose one of the one or more infusional chemotherapy protocols; and generates a protocol order for treatment of the patient based on the selected infusional chemotherapy protocol.

18. The computer program product of claim 17, further comprising a sixth executable code section that allows the user to modify the selected infusional chemotherapy protocol resulting in a modified protocol order for treatment of the patient.

19. The computer program product of claim 16, wherein the computer-executable code sections are executed on a computer that comprises a web based internet technology for conducting a plurality of multilateral transactions.

20. The computer program product of claim 19, wherein web based internet technology for conducting a plurality of multilateral transactions comprises:
transacting with a plurality of physician providers;
transacting with a plurality of pharmaceutical manufacturers;
transacting with a plurality of governmental agencies; and
transacting with a plurality of private entities.
